(19) United States
(12) Patent Application Publication
(10) Pub. No.: US 2024/0412401 A1
(43) Pub. Date: Dec. 12, 2024

(54) IMAGE PROCESSING DEVICE, IMAGE PROCESSING METHOD, AND STORAGE MEDIUM

(71) Applicant: NEC Corporation, Minato-ku, Tokyo (JP)

(72) Inventors: Hisaya WAKAYAMA, Tokyo (JP); Masatsugu OGAWA, Tokyo (JP); Masumi ICHIEN, Tokyo (JP); Takuma KOGO, Tokyo (JP)

(73) Assignee: NEC Corporation, Minato-ku, Tokyo (JP)

(21) Appl. No.: 18/699,342

(22) PCT Filed: Oct. 14, 2021
(86) PCT No.: PCT/JP2021/038115

§ 371 Date: Apr. 8, 2024

(51) Int. Cl. G06T 7/70; G06T 3/40

(52) U.S. Cl. CPC G06T 7/70; G06T 3/40; G06T 2200/24; G06T 2207/20101

(57) ABSTRACT

An operation performed for designating a position in an image is detected, and an enlarged image of a vicinity area at that position is displayed. Information regarding a target appearing in the enlarged image is acquired, and information regarding that target is displayed.

### TECHNICAL FIELD

The present invention relates to an image processing device, an image processing method, and a storage medium.

### BACKGROUND ART

Many technologies for improving user operability of displayed information are being considered. Patent Document 1 discloses technology for detecting an area of an image to be enlarged in order to improve the operability for inputting information.

### CITATION LIST

### Patent Literature

[Patent Document 1] Japanese Unexamined Patent Application, First Publication No. 2000-250681

### SUMMARY OF THE INVENTION

### Problems to be Solved by the Invention

In operations for using displayed information to send control instructions, technology for improving the operability associated with the selection of targets appearing in captured images is sought.

Therefore, an objective of the present invention is to provide an image processing device, an image processing method, and a storage medium that solve the above-mentioned problem.

### Means for Solving the Problems

According to a first aspect of the present invention, an image processing device is provided with detecting means for detecting that a first operation for designating a position in an image has been performed, first displaying means for displaying an enlarged image of a vicinity area at the position, acquiring means for acquiring information regarding a target appearing in the enlarged image, and second displaying means for displaying information regarding the target.

According to a second aspect of the present invention, an image processing method involves detecting that a first operation for designating a position in an image has been performed, displaying an enlarged image of a vicinity area at the position, acquiring information regarding a target appearing in the enlarged image, and displaying information regarding the target.

According to a third aspect of the present invention, a storage medium stores a program for making a computer in an image processing device function as detecting means for detecting that a first operation for designating a position in an image has been performed, first displaying means for displaying an enlarged image of a vicinity area at the position, acquiring means for acquiring information regarding a target appearing in the enlarged image, and second displaying means for displaying information regarding the target.

### Advantageous Effects of Invention

According to the present invention, the operability for selecting targets appearing in a captured image can be improved.

### BRIEF DESCRIPTION OF THE DRAWINGS

FIG. 1 A diagram illustrating the schematic configuration of a control system provided with an image processing device according to the present embodiment.

FIG. 2 A functional block diagram of an image processing device according to the present embodiment.

FIG. 3 A diagram illustrating an example of display information.

FIG. 4 A flow chart indicating the flow of processing in the image processing device.

FIG. 5 A diagram illustrating another display example of an enlarged image.

FIG. 6 A diagram illustrating the configuration of the image processing device according to the present embodiment.

FIG. 7 A flow chart indicating the processing flow by the image processing device according to the present embodiment.

FIG. 8 A hardware configuration diagram of a control device according to the present embodiment.

### EXAMPLE EMBODIMENT

Hereinafter, an image processing device according to an embodiment of the present invention will be explained with reference to the drawings.

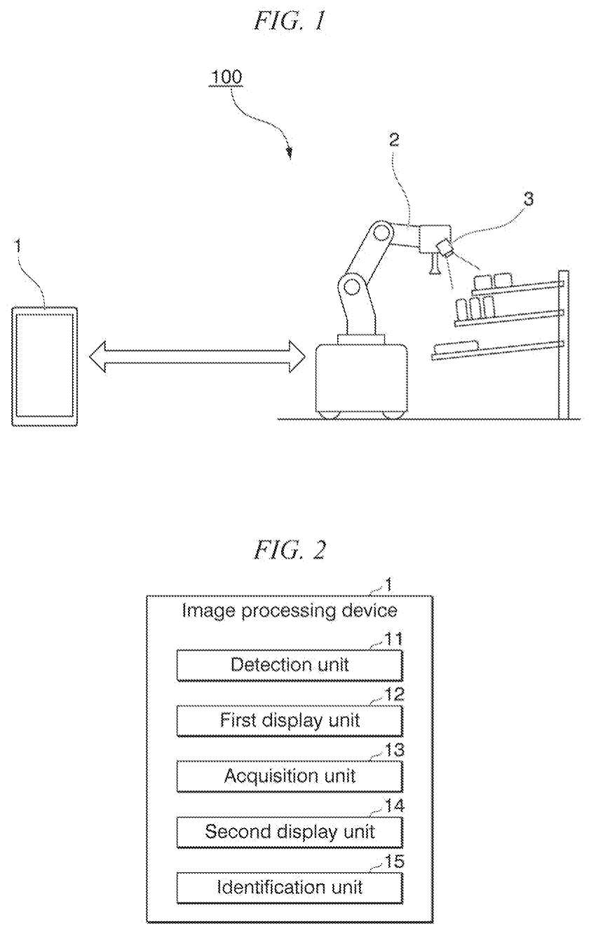

FIG. 1 is a diagram illustrating the schematic configuration of a control system 100 provided with an image processing device according to the present embodiment. The control system 100 has an image processing device 1, a control target 2, and an image capture device 3. The image processing device 1 is communicably connected with a control target 2 and an image capture device 3 over a communication network.

In the example illustrated in FIG. 1, a user operates the image processing device 1. The image processing device 1 controls the control target 2 based on the user operations. The image capture device 3 is, for example, a camera, and captures images of an area of space in which the actions or the state of the control target 2 appear, an area of space in which the control target 2 is performing actions, etc. When the control target 2 is a robot arm, the image capture device 3, for example, captures images of an area in an angle of view in which the state of movement of a target object gripped by the robot arm from a movement starting point to a movement destination can be captured. The image processing device 1 acquires the images captured by the image capture device 3. The image processing device 1 is a device including a display having display functions such as, for example, a tablet terminal, a personal computer, or a smartphone. The display may, for example, be a touch panel-type display.

FIG. 2 is a functional block diagram of an image processing device according to the present embodiment.

The image processing device 1 has the functions of a detection unit 11, a first display unit 12, an acquisition unit 13, a second display unit 14, and an identification unit 15. The image processing device 1 executes an image processing program. As a result thereof, the image processing device 1 achieves the functions of the detection unit 11, the first display unit 12, the acquisition unit 13, the second display unit 14, and the identification unit 15.

The detection unit 11 detects that an operation to designate a position in a captured image acquired by the image processing device 1 has been performed. In the case in which, for example, the image processing device 1 is provided with a touch panel-type display, this designating operation may be an operation for designation by touching the touch panel display with a finger or the like. Additionally, in the case in which the image processing device 1 is provided with a mouse for serving as an input device, the designating operation may be an operation for designation by moving a cursor displayed on a display of a captured image with a mouse and clicking at the position to be designated.

The first display unit 12 displays an enlarged image of the vicinity area at the position designated in the captured image.

The acquisition unit 13 acquires information regarding a target (hereinafter referred to as “target information”) appearing in the enlarged image of the captured image.

The second display unit 14 displays the target information appearing in the enlarged image.

The identification unit 15 identifies, as a position selected (hereinafter referred to as “selected position”) in the captured image, a position designated in a state in which the enlarged image is displayed. In the identification unit 15, for example, when the image processing device 1 is a touch panel-type display, by ending a touch operation, such as by removing a finger at the position being designated, in a state in which the enlarged image is displayed, that position may be identified as the selected position. Additionally, in the case in which the image processing device 1 is provided with a mouse serving as an input device, by moving a cursor displayed on a display of the captured image with a mouse, in a state in which the enlarged image is displayed, and clicking at the position to be designated, that position may be identified as the selected position.

The target information displayed by the second display unit 14 may, for example, be information indicating the distance from the image capture device 3 to the target appearing in the captured image. Additionally, the target information displayed by the second display unit 14 may, for example, be information regarding the normal direction on a surface of the target in a coordinate system for the space being captured by the image capture device 3. The normal direction on a surface of a target is one form of information representing that surface. The target information may be other information representing the surface aside from the normal direction. Alternatively, the target information may be information regarding the temperature on the surface of the target. In the case in which the target information is information indicating the distance from the image capture device 3 to the target appearing in the captured image, the distance from the image capture device 3 to the target appearing in the captured image may be detected, for example, by a TOF sensor, etc. provided in the image capture device 3. In the case in which the target information is information regarding the normal direction on a surface of the target in a coordinate system in the space being captured by the image capture device 3, the normal direction on the surface of the target may be detected, for example, by a 3D modeling function provided in the image capture device 3. In the case in which the target information is information regarding the temperature on the surface of the target, the temperature on the surface may be detected by a temperature sensor, etc. provided in the image capture device 3.

In the case in which the target information is information indicating the distance from the image capture device 3 to the target appearing in the captured image, the target information may, more specifically, be information in which the enlarged image is divided into multiple sections and in which the distance between the image capture device 3 and the surface of the target is indicated for a pixel located at the center of each section. Additionally, in the case in which the target information appearing in the enlarged image is information regarding the normal direction on the surface of the target, the target information may, more specifically, be information in which the enlarged image is divided into multiple sections and in which the normal direction on the surface of the target is indicated for a pixel located at the center of each section. Additionally, in the case in which the target information appearing in the enlarged image is information regarding the temperature on the surface of the target, the target information may, more specifically, be information in which the enlarged image is divided into multiple sections and in which the temperature on the surface of the target is indicated for a pixel located at the center of each section. The division into multiple sections may be implemented by means of pixels.

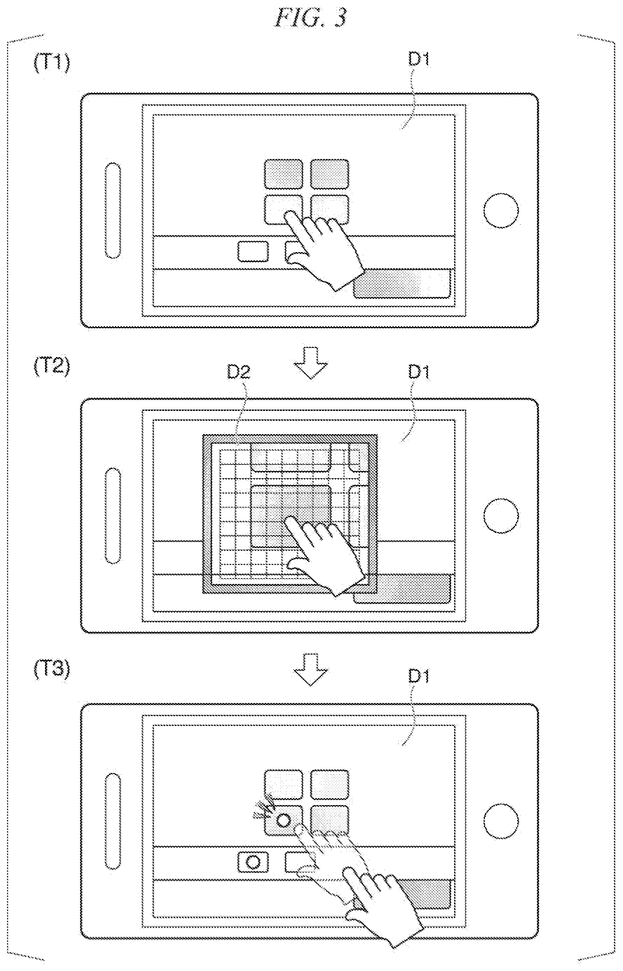

FIG. 3 is a diagram indicating an example of display information.

The image processing device 1 acquires a captured image D1 from the image capture device 3 at the time T1. The captured image D1 may be a moving image or may be a still image.

The image processing device 1 displays the captured image D1 on a display. For convenience of explanation, the display will be assumed to be a touch panel-type display as one example.

The image processing device 1 detects that an operation (for example, a touching operation with a finger) is being performed at a certain position in the captured image D1. The image processing device 1 detects that position in the captured image D1. The image processing device 1, for example, displays the enlarged image D2 in the vicinity (or the periphery) of the position at which the operation is being performed while it is detected that the operation is being performed (for example, while the touch panel-type display continues to be touched with a finger). The enlarged image D2 is an image in which, an area in the vicinity of the position at which the operation is being performed in the captured image D1 being displayed on the touch panel-type display, is displayed in an enlarged manner. The image processing device 1 can be considered to display the enlarged image D2 so as to be linked with the captured image D1.

The image processing device 1 detects, for example, that the operation is not being performed (for example, that the finger is removed from the touch panel-type display) while the enlarged image D2 is being displayed. The time at which this is detected is represented by “time T3”. In this case, the image processing device 1 stops displaying the enlarged image D2. That is, the image processing device 1 deletes the enlarged image D2 from the display information on the display. Additionally, the image processing device 1, for example, in response to detecting that the operation is not being performed, identifies a position at which the operation ended as a selected position.

According to the processing in such an image processing device 1, the enlarged image D2 is displayed so as to be linked with the captured image D1. For this reason, the operability when inputting instructions for a target appearing in the displayed image D1 can be improved.

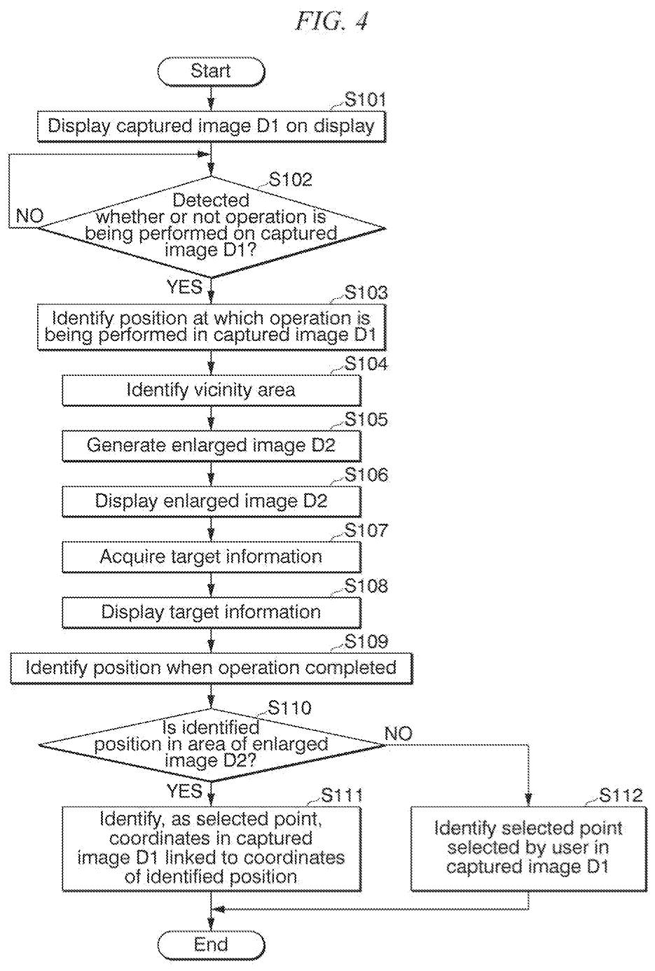

Next, the processing in the image processing device 1 will be explained with reference to FIG. 4. FIG. 4 is a flow chart indicating the flow of processing in the image processing device 1.

The first display unit 12 displays a captured image D1 acquired from the image capture device 3 on a display (step S101). The detection unit 11 detects whether or not an operation (first operation) is being performed on the captured image D1 (step S102). In the case in which an operation being performed on the captured image D1 has been detected, the detection unit 11 identifies the position at which the operation is being performed in the captured image D1 (step S103). The detection unit 11 calculates coordinates corresponding to the identified position in a coordinate system for the captured image D1. The detection unit 11 outputs the coordinate information representing the calculated coordinates to the first display unit 12.

The first display unit 12 inputs the coordinate information from the detection unit 11 and identifies a vicinity area including the coordinates represented by the coordinate information (step S104). For example, the first display unit 12 identifies a prescribed area centered at said coordinates as the vicinity area. The prescribed area is an area, for example, with a rectangular, circular, elliptical, etc. shape, with the size of the shape being determined in advance. The prescribed area may be represented by the coordinates of the vertices of a rectangle, by the radius of a circle, etc. For convenience, the prescribed area will be assumed to be a circle of a prescribed size centered at the calculated coordinates. In this case, the first display unit 12 identifies, as the vicinity area, the inside of a circle having a prescribed size centered at the calculated coordinates. The first display unit 12 generates an enlarged image D2 for the vicinity area (step S105). The enlarged image D2 that has been generated is displayed on a display (step S106). In this case, the first display unit 12 may display the enlarged image D2 on the display in a form in which the center of the enlarged image D2 is aligned with the identified position. The first display unit 12, after having generated the enlarged image D2, may prepare coordinate information in which the coordinates of pixels in the enlarged image D2 are linked with coordinates of pixels in the captured image D1.

The acquisition unit 13, in response to identifying the vicinity area, acquires target information regarding an area including the vicinity area (step S107). As mentioned above, the target information is, for example, information such as the distance from the image capture device 3 to the target, the normal direction on the surface of the target, the temperature on the surface of the target, etc. The acquisition unit 13, for example, acquires target information corresponding to the respective pixels included in the vicinity area from among the target information.

The process for acquiring target information regarding the area including the vicinity area will be explained in more detail. The captured image D1, for example, has target information in which coordinates representing the positions of respective pixels in the captured image D1 are linked with information at those coordinates. In the case in which a pixel represents a target, the target information includes information in which the position representing that pixel is linked with information regarding the position of that pixel (for example, the distance from the image capture device 3 to the target, the temperature, etc.). As another method, the captured image D1 may include information in which the captured image D1 has been divided into multiple sections in advance, and in which the respective sections are linked with information regarding the respective sections. For example, if the target information is information indicating the normal direction on the target, the information indicating the normal direction may be calculated in advance by acquiring the distance from the image capture device 3 to the target at the center pixel in each section and the pixels in the periphery thereof, and by calculating the change in the distance relative to the change in the pixel position, and the captured image D1 may hold the information so as to be linked with the sections on the target.

The acquisition unit 13 acquires, from the target information, information linked to the positions of the respective pixels in a vicinity area. The acquisition unit 13 outputs the acquired target information to the second display unit 14. The target information may be acquired from the image capture device 3 separately from the captured image D1. Alternatively, the acquisition unit 13 may acquire the target information, via the communication network, from a sensor measuring the target. For convenience of explanation, the target information regarding the vicinity area is indicated to be “information of interest”. In other words, in step S106, the acquisition unit 13 acquires the information of interest from the target information.

The acquisition unit 13 outputs the information of interest to the second display unit 14. The second display unit 14 displays the acquired information of interest in the enlarged image D2 (step S108). For example, suppose that the target information includes information representing the distance from the image capture device 3 to the target. In this case, the second display unit 14 acquires, from the target information, information of interest that is information representing the distance. The second display unit 14, for example, displays the distance represented by the information of interest on the pixels in the enlarged image D2. The second display unit 14 may display the information of interest in a form such as a heat map or contour lines. Alternatively, the second display unit 14 may display the information of interest in a form represented by a numerical value.

For example, suppose that the target information includes information representing the normal direction on the surface of the target. In this case, the second display unit 14 acquires, from the target information, information of interest that is information representing the normal direction, and displays the acquired information of interest. The second display unit 14 may display the normal in a form in which the normal direction is represented by an arrow. Alternatively, the second display unit 14 may display the normal direction in a form representing the normal direction by a straight line.

For example, suppose that the target information includes information representing the temperature on the surface of the target. In this case, the second display unit 14 acquires, from the target information, information of interest that is information representing the temperature, and displays the acquired information of interest. The second display unit 14 may display the temperature in a form represented by a numerical value, or may display the temperature in a form represented by a heat map.

The second display unit 14, for example, while detecting that an operation for designating a position is being performed in the enlarged image, displays the enlarged image D2 and the information of interest.

Upon detecting that an operation is not being performed, the detection unit 11 determines that the operation has ended. The detection unit 11 identifies the position at the time the operation ended (step S109). This process is an example of a process by which the identification unit 15 identifies, as a selected point in an image, information indicating the position designated by the second operation. The second operation may be an operation to touch the enlarged image with a finger, or may be an operation to remove the finger from a touch panel-type display. The detection unit 11 outputs the identified position to the identification unit 15.

The identification unit 15 determines whether or not the identified position is in the area of the enlarged image D2 (step S110). In the case in which the identified position is in the area of the enlarged image D2, the identification unit 15 identifies, as a selected point, coordinates in the above-mentioned coordinate information (i.e., coordinates in the captured image D1) linked to the coordinates at that position (step S111). In the case of a “No” in step S110, the identification unit 15 identifies the coordinates representing that position as the selected point (step S112). Due to the process described above, the process of identifying a selected point selected by a user in the captured image D1 ends.

The identification unit 15 may generate an instruction signal including coordinates indicating the selected point identified in the captured image D1. In this case, the identification unit 15 transmits the instruction signal to the control target 2. The control target 2 acquires the coordinates of the selected point in the captured image D1 included in the instruction signal. The control target 2 may execute a process of conversion from the coordinate system in the captured image D1 to a spatial coordinate system for the control target 2. In this case, the control target 2 converts the coordinates of the selected point in the captured image D1 to coordinates in the spatial coordinate system of the control target 2.

According to the processing in the image processing device 1 described above, when a user inputs the selected point in the captured image D1, an enlarged image D2 for the neighborhood of the position at which an operation is being performed is displayed. Then, upon detecting that the operation is not being performed, the image processing device 1 recognizes the position at which the operation ended to be the selected point. As a result thereof, the selected point can be designated while looking at an enlarged image D2 of the neighborhood of the position at which the operation is being performed, thereby improving the operability. Additionally, according to the processing described above, information of interest regarding the target is displayed in the enlarged image D2. As a result thereof, the user can designate the selected point while checking the information of interest, thereby improving the operability.

Additionally, the identification unit 15 may further include target information at the selected point as an instruction signal. For example, information indicating the normal direction on the target may be included as target information. As a result thereof, the control target 2 can use the information indicating the normal direction on the target to determine an appropriate approach to the target (for example, the fingertip angle when picking up the target). As a result, the user can designate the selected point by assuming that the control target 2 will be notified of the target information, thereby improving the operability.

### Other Embodiments

The second display unit 14 may identify a candidate position, which is a candidate for being a selected point, based on target information in the enlarged image D2, and may display the identified candidate position in the enlarged image D2. For example, the second display unit 14 may identify at least a portion of the positions with little variation in the vicinity in the information representing the surface of the target to be candidate positions. More specifically, the normal directions can be used to identify an area in which the differences in the angles of the normal directions between adjacent pixels are less than a threshold value to be areas with little variation in the normal direction, and at least a portion of this identified area can be identified to be a candidate position. The second display unit 14 may prepare an enlarged image D2 representing the colors of pixels corresponding to the candidate position in a different form (i.e., in a form allowing the candidate position to be discerned) than the periphery of the candidate position, and may display the enlarged image D2 that has been prepared. As a result thereof, relatively flat positions can be detected on the surface of the target. The candidate position is not limited to a single position and may be multiple positions.

For example, in the case in which the target is a target object that is manipulated (or held, etc.) by a robot such as a robot arm, and the image processing device 1 is an operating terminal for operating the actions of the robot, the effect that the robot can reliably perform actions on the target by the process of identifying the candidate position can be obtained. This is because, due to the process of displaying the candidate position, a location at which the robot can more reliably perform actions can be indicated.

The second display unit 14 may identify the candidate position based on the distance from the image capture device 3 to the target. For example, the second display unit 14 may identify, as a candidate position, the position on the target for which the distance from the image capture target to the target is the shortest. The second display unit 14 prepares an enlarged image D2 representing the candidate position in a discernible form, and displays the enlarged image D2 that has been prepared. For example, in the case in which the target is a target object that is manipulated (or held, etc.) by a robot such as a robot arm, and the image processing device 1 is an operating terminal for operating the actions of the robot, the effect that the robot can be operated so as to reduce the movement amount of the robot by the process of identifying the candidate position can be obtained. This is because the process of displaying the candidate position results in a small amount of movement being required when the robot moves to the candidate position.

Additionally, for example, the second display unit 14 may identify, as the candidate position, the position at which the variation in the distance to the target in the vicinity is the smallest. The second display unit 14 prepares an enlarged image D2 representing the candidate position in a discernible form, and displays the enlarged image D2 that has been prepared. As a result thereof, a position at which the variation in the distance is small, i.e., a position at which the surface is flat, can be designated, and the process of identifying the candidate position can indicate a location at which the robot can more reliably perform actions.

For example, in the case in which the target is a target object that is manipulated (or held, etc.) by a robot such as a robot arm, and the image processing device 1 is an operating terminal for operating the actions of the robot, the effect that the robot can be operated so as to reduce the movement amount of the robot by the process of identifying the candidate position can be obtained. This is because, due to the process of displaying the candidate position results in a small amount of movement being required when the robot moves to the candidate position.

The image processing device 1 may display warning information on the display based on the relationship between the position at which the operation ended and the candidate position. For example, the detection unit 11 calculates the distance between the candidate position and the position at which the operation became undetectable. The detection unit 11 outputs, to the second display unit 14, the distance between the candidate position and the position at which the operation became undetectable. In the case in which the distance between the candidate position and the position at which the operation became undetectable is a prescribed distance threshold value or greater, the second display unit 14 displays warning information indicating that the candidate position is far away from the selected point. As a result thereof, the image processing device 1 can reduce operating errors occurring when a user inputs the selected point in the captured image D1.

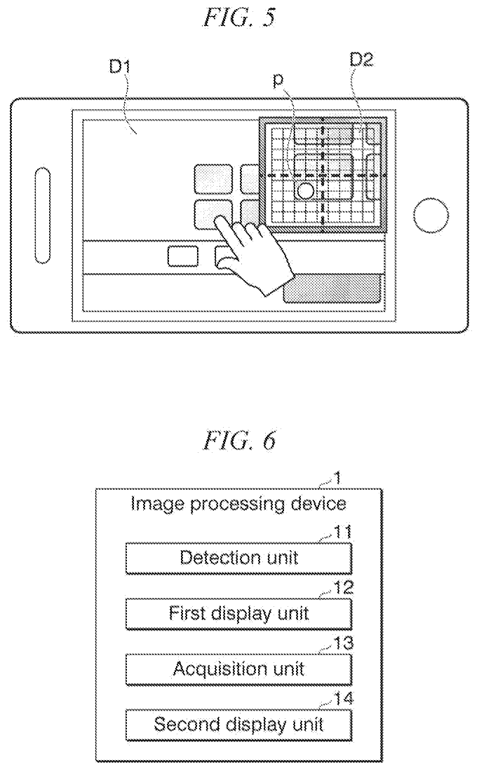

Next, another display example will be explained with reference to FIG. 5. FIG. 5 is a drawing indicating another display example of the enlarged image.

In the example mentioned above, the second display unit 14 displays the enlarged image D2 on the display so that the center of the enlarged image D2 is aligned with the selected point that has been identified. However, it is not required that the center of the enlarged image D2 and the selected point that has been identified be aligned. In this case, the second display unit 14, for example, displays the enlarged image D2 so that the area in which the enlarged image D2 is displayed does not overlap with the selected point.

Suppose that, in a state in which the enlarged image D2 is displayed, the image processing device 1 has detected that an operation is being performed on the display. Furthermore, suppose that the operation is an operation in which the position moves. In this case, the second display unit 14 may, in accordance with the movement amount and the movement direction of the position at which the operation is being performed, move a point p displayed in the enlarged image by tracking the values by which the operation is being performed. Upon detecting that an operation is not being performed, the detection unit 11 detects the position in the enlarged image D2 at which the point p was displayed in the enlarged image D2 at that timing. The detection unit 11 outputs, to the identification unit 15, the position in the enlarged image D2 at which the point p was displayed in the enlarged image D2 at the timing when the operation is no longer detected as being performed. The identification unit 15 determines, as the selected point, the coordinates in the captured image D1 at which the coordinate information is recorded in association with the coordinates of the position in the enlarged image D2 at which the point was displayed in the enlarged image D2 at that timing.

In the explanation above, in accordance with the movement amount and the movement direction of the position of a finger in the enlarged image or the captured image for which the display position does not move in a touch panel-type display, the second display unit 14 performs a process for moving the point p displayed in the enlarged image by tracking the values of the movement amount and the movement direction thereof. However, the second display unit 14 may, in accordance with the movement amount and the movement direction of the position of the finger, perform a process for moving the enlarged image by tracking the values of the movement amount and the movement direction thereof. In other words, in accordance with the movement of the position of the finger, the process for moving the enlarged image may be performed so that the point p moves in conjunction with the position of the finger and is located at the center of the enlarged image.

Due to this process, a selected point may be identified while checking both the position of the selected point in the captured image D1 and the position of the selected point in the enlarged image D2.

Next, the image processing device will be explained with reference to FIG. 6 and FIG. 7. FIG. 6 is a diagram illustrating the configuration of the image processing device according to the present embodiment. FIG. 7 is a flow chart indicating the processing flow in an image processing device according to the present embodiment.

The image processing device 1 is provided with a detection unit 11, a first display unit 12, an acquisition unit 13, and a second display unit 14.

The detection unit 11 detects that an operation is being performed in a captured image D1 (step S201).

The first display unit 12, for an image designated at a position at which the operation is being performed, prepares an enlarged image D2 of the neighborhood of the position being designated in the image, and displays the enlarged image D2 that has been prepared (step S202).

The acquisition unit 13 acquires information of interest regarding a target included in the enlarged image D2 (step S203).

The second display unit 14 displays the information of interest that has been acquired (step S204).

The detection unit 11 in FIG. 6 can be realized by using a function similar to the function of the detection unit 11 in FIG. 2. The first display unit 12 in FIG. 6 can be realized by using a function similar to the function of the first display unit 12 in FIG. 2. The acquisition unit 13 in FIG. 6 can be realized by using a function similar to the function of the acquisition unit 13 in FIG. 2. The second display unit 14 in FIG. 6 can be realized by using a function similar to the function of the second display unit 14 in FIG. 2.

### (Hardware Configuration Example)

A configuration example of hardware resources for using a single computation processing device (information processing device, computer) to realize the image processing device 1 according to the respective embodiments of the present invention described above will be explained. However, this image processing device 1 may be realized by physically or functionally using at least two computation processing devices. Additionally, the image processing device 1 may be realized as a dedicated device.

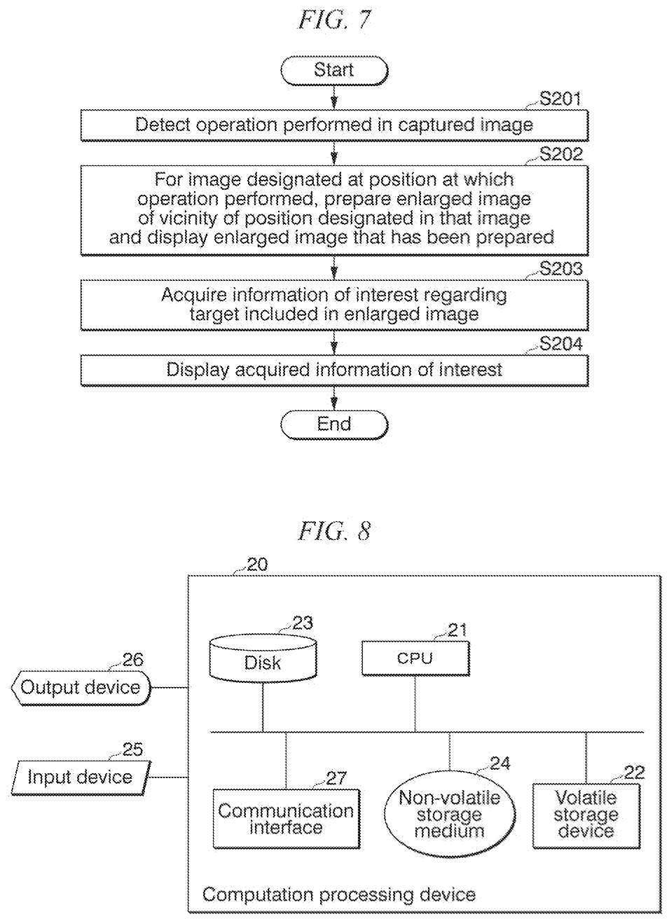

FIG. 8 is a block diagram schematically illustrating a hardware configuration example of a computation processing device capable of realizing an image processing device according to the respective embodiments of the present invention. The computation processing device 20 has a central processing device (Central Processing Unit, hereinafter referred to as a “CPU”) 21, a volatile storage device 22, a disk 23, a non-volatile recording medium 24, and a communication interface (hereinafter referred to as a “communication IF”) 27. The computation processing device 20 may be capable of connecting to an input device 25 and an output device 26. The computation processing device 20 can exchange information with communication devices and other computation processing devices via the communication IF 27.

The non-volatile recording medium 24 is, for example, a compact disc or a digital versatile disc that is computer-readable. Additionally, the non-volatile recording medium 24 may be a universal serial bus memory (USB memory), a solid-state drive, etc. The non-volatile recording medium 24 holds a relevant program even when not supplied with electric power, allowing the program to be carried. The non-volatile recording medium 24 is not limited to the media mentioned above. Additionally, instead of the non-volatile recording medium 24, the program may be carried over the communication interface 27 and a communication network.

The volatile storage device 22 is computer-readable and can temporarily store data. The volatile storage device 22 is a memory such as a DRAM (dynamic random access memory) or an SRAM (static random access memory).

That is, the CPU 21, when executing a software program (computer program, hereinafter referred to simply as a “program”) stored in the disk 23, copies the program to the volatile storage device 22 and executes computational processes. The CPU 21 reads data required to execute the program from the volatile storage device 22. When needing to display output results, the CPU 21 displays the output results on the output device 26. When a program is input from an external source, such as another device that is communicably connected, the CPU 21 reads the program from the input device 25.

The CPU 21 interprets and executes a control program (FIG. 4 or FIG. 7) in the volatile storage device 22 corresponding to the functions (processing) represented by the respective units illustrated in FIG. 2 or FIG. 6 described above. The CPU 21 executes the processes explained in the respective embodiments of the present invention described above.

That is, in such cases, the respective embodiments of the present invention can also be understood to be capable of being implemented by a relevant control program. Furthermore, the respective embodiments of the present invention can also be understood to be capable of being implemented by means of a computer-readable non-volatile recording medium in which the relevant control program is recorded.

Additionally, the above-mentioned program may be for realizing just some of the functions described above. Furthermore, it may be capable of realizing the functions described above by being combined with a program already recorded in a computer system, i.e., it may be a so-called difference file (difference program).

The present invention has been explained above with the embodiments described above as exemplary cases. However, the present invention is not limited to the embodiments described above. That is, various modes that can be contemplated by a person skilled in the art may be applied to the present invention within the scope of the present invention.

### REFERENCE SIGNS LIST

1 Image processing device
2 Control target
3 Image capture device
100 Control system
11 Detection unit
12 First display unit
13 Acquisition unit
14 Second display unit
15 Identification unit

What is claimed is:

1. An image processing device comprising:
at least one memory configured to store instructions; and
at least one processor configured to execute the instructions to:
detect that a first operation for designating a position in an image has been performed;
display an enlarged image of a vicinity area at the position;
acquire information regarding a target appearing in the enlarged image; and
display information regarding the target.

2. The image processing device according to claim 1, wherein the at least one processor is configured to execute the instructions to:
display information regarding the target in the enlarged image.

3. The image processing device according to claim 1, wherein the at least one processor is configured to execute the instructions to:
acquire, as information regarding the target, information indicating a distance from an image capture device capturing the image to a prescribed position on the target, and display the information indicating the distance.

4. The image processing device according to claim 1, wherein the at least one processor is configured to execute the instructions to:
acquire, as information regarding the target, information representing a surface of the target at a prescribed position on the target, and display the information representing the surface.

5. The image processing device according to claim 4, wherein
the information representing the surface is information indicating a normal direction on the surface.

6. The image processing device according to claim 1, wherein the at least one processor is configured to execute the instructions to:
display information regarding the target while receiving a second operation designating a position in the enlarged image.

7. The image processing device according to claim 6, wherein the at least one processor is configured to execute the instructions to:
display a candidate position regarding the second operation, identified based on information regarding the target in the enlarged image.

8. The image processing device according to claim 7, wherein the at least one processor is configured to execute the instructions to:
identify, as the candidate position, at least a portion of positions at which there is little variation in the vicinity in the information representing the surface of the target.

9. The image processing device according to claim 7, wherein the at least one processor is configured to execute the instructions to:
identify the candidate position based on a distance from an image capture device capturing the image to a position on the target.

10. The image processing device according to claim 9, wherein the at least one processor is configured to execute the instructions to:
identify, as the candidate position, at least a portion of positions at which there is little variation in the vicinity in the distance from the image capture device capturing the image to the position on the target.

11. The image processing device according to claim 9, wherein the at least one processor is configured to execute the instructions to:
identify, as the candidate position, at least a portion of positions at which the distance from the image capture device capturing the image to the position on the target is short.

12. The image processing device according to claim 6, wherein the at least one processor is further configured to execute the instructions to:
detect the second operation and identify, as a selected point in the image, information indicating a position designated by the second operation.

13. The image processing device according to claim 12, wherein the at least one processor is further configured to execute the instructions to:
transmit out an instruction signal including coordinates indicating the selected point.

14. The image processing device according to claim 13, wherein
the instruction signal further includes information regarding the target at the selected point.

15. An image processing method comprising:
detecting that a first operation for designating a position in an image has been performed;
displaying an enlarged image of a vicinity area at the position;
acquiring information regarding a target appearing in the enlarged image; and
displaying information regarding the target.

16. A non-transitory storage medium that stores a program for causing a computer in an image processing device to execute processes, the processes comprising:
detecting that a first operation for designating a position in an image has been performed;
displaying an enlarged image of a vicinity area at the position;
acquiring information regarding a target appearing in the enlarged image; and
displaying information regarding the target.
